(19) United States
(12) Patent Application Publication
(10) Pub. No.: US 2007/0084027 A1
(43) Pub. Date: Apr. 19, 2007

(54) URN WITH NOVEL SECURING DEVICE

(76) Inventor: Karin J. Walczak, Hawthorn Woods, IL (US)

Correspondence Address: JUSTIN LAMPEL, 2111 PRIMROSE LANE, SCHAUMBURG, IL, 60194, US

(21) Appl. No.: 11/163,047

(22) Filed: Oct. 3, 2005

(51) Int. Cl. A61G 17/00

(52) U.S. Cl. 27/1

(57) ABSTRACT

A burial urn for cremated remains which utilizes a top loaded lid. The urn lacks a hole and plug on the bottom surface. The urn prevents any leakage of contents by means of a bottom hole. The lid may have a gasket, a threaded member or other means for securing the lid onto the urn. The lid may also have a locking device for restricted access to the interior of the urn.

### BACKGROUND OF THE INVENTION

The present invention generally relates to a cinerary urn receptacle for the cremated remains of humans or pets. (Although the below disclosure merely lists humans, it should be understood that the ashes may be that of a human, pet or other being.) The urn may have a single opening at the top end which completely secures the contents within the urn. The urn is loaded from the top. Further, the urn lacks a hole on its bottom surface; thereby preventing ashes from escaping.

Over the past couple decades, cremation has become increasingly more popular. The increase in popularity has been linked to a number of factors including: 1) the rising costs of being interred into the ground, 2) environmental concerns with burial, 3) the ever increasing mobile society and 4) the desire by people to keep the remains of a loved one in close proximately to them.

After completion of the cremation process, the ashes of the loved one are all that generally remain. Often, people dispose of the ashes of the loved one in water, on land or even recently, in outer-space. Alternatively, people elect to keep the ashes of a loved person or pet in an urn close to them in, for example, their residence.

Typically, the ashes of the loved one are placed in a vase, cinerary urn or other receptacle (hereinafter called an urn). Some of these urns are made from valuable metals and/or have jewels and/or elaborate designs on their outer-surfaces. Such elaborate receptacles are often created as a tribute to the life of the departed person. Further, some of these urns are even biodegradable.

Most, if not all, of these urns are loaded with the ashes through a hole in the bottom of urn. Next, the ashes are sealed within the urn by means of a “plug” which is screwed into the hole in the bottom of the urn.

While these urns fulfill their respective, particular objectives and requirements, the prior art does not disclose an urn which is loaded and sealed from the top by a lid and/or an opening. Further, previous urns do not have a bottom lacking a hole.

A need, therefore, exists for an improved urn which is loaded from the top and secured from the top by a sealable lid and/or a plug. A still further need exists for a novel urn which lacks a hole in the bottom surface of the urn.

### SUMMARY OF THE INVENTION

The present invention is directed toward a novel urn for storing the ashes of a human or other animal. Unlike existing urns, the urn of the present invention is loaded from the top. Further, the urn of the present invention lacks a hole on its bottom surface. The urn seals the ashes within the interior by means of a rubber gasket, threaded members, a bolt or any combination thereof. The urn may also seal by means of a brass band, bolt and/or decorative padlock.

In the preferred embodiment, the urn is constructed from marble or other cultured stone; however, the urn may be constructed from metal, wood, plastic or any other suitable material.

In an embodiment, the urn may be constructed from an entirely or partially biodegradable material.

In an embodiment, the urn has a gasket which seals a lid onto the urn.

In another embodiment, the gasket is made from rubber.

In still another embodiment, the gasket is made from silicone.

In another embodiment, the contents of the urn are sealed by means of a brass band.

In yet another embodiment, the lid may be secured onto the urn by means of complementary threaded members on the lid and on the urn.

In still another embodiment, the urn may have an opening at the top end of the urn for receiving the contents of the urn.

In still another embodiment, the contents of the urn are secured by a brass band and a screw bolt.

In yet another embodiment, the contents of the urn are locked inside the urn by a padlock.

In another embodiment, a bolt may be used to secure the contents of the urn within an interior of the urn.

And in another embodiment of the present invention, the lid is secured to the urn by at least two of the following: complementary threaded members, a gasket and/or a bolt.

The primary advantage of the present invention is to provide an urn that may be loaded from the top.

A further advantage of the present invention is to provide an urn that prevents ashes from leaking out of an opening on the bottom surface of the urn.

Another advantage of the present invention is to provide an urn which seals the ashes within the interior by means of a gasket on a plug.

Still another advantage of the present invention is to provide an urn which seals the ashes within the interior of the urn by means of two complementary threaded members.

Yet another advantage of the present invention is to provide an urn which is easily re-sealable.

A further advantage of the present invention is to provide an urn which lacks an opening on the bottom surface.

A further advantage of the present invention is to provide an urn which has unique decorative design surrounding the exterior surface(s) of the urn.

A still further advantage of the present invention is to provide a biodegradable urn.

For a more complete understanding of the above listed features and advantages of the urn, reference should be made to the following detailed description of the preferred embodiments and to the accompanying drawings. Further, additional features and advantages of the present invention are described in, and will be apparent from, the detailed description of the preferred embodiments and from the drawings.

### BRIEF DESCRIPTION OF THE DRAWINGS

FIG. 1 illustrates a front perspective view of an urn of the present invention.

FIG. 2 illustrates a side perspective view of a lid of the present invention wherein the lid has a threaded member.

FIG. 3 illustrates a front perspective view of an urn of the present invention wherein the urn has hole at the top end.

FIG. 4 illustrates a side perspective view of a lid of the present invention wherein the lid has a threaded member and a gasket.

FIG. 5 illustrates front perspective view of a lid of the present invention being secured onto an urn of the present invention.

### DETAILED DESCRIPTION OF THE PREFERRED EMBODIMENTS

The present invention generally provides a cinerary urn receptacle for the cremated remains of a human or pet. The urn may have a single opening at the top end which completely secures contents within the urn. The urn is loaded from the top. Further, the urn, unlike most, if not all urns, lacks an opening on the bottom surface in which ashes may escape.

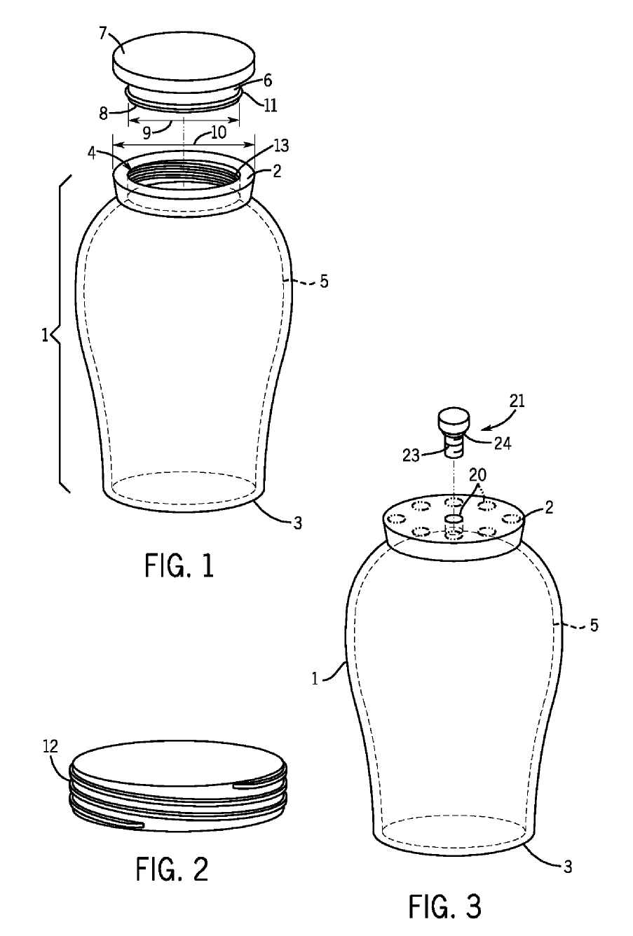

Referring now to the drawings wherein like numerals refer to like parts, FIG. 1 generally illustrates an urn 1 which is loaded from the top. The urn 1 has a top end 2, a bottom end 3, an opening 4 and an interior 5. FIG. 1 illustrates a generally cylindrical urn 1, however, it should be understood that the urn 1 may be of any shape, including, but not limited to, cubic or spherical. Preferably the urn 1 is made from marble or metal. However, the urn 1 may be made from plastic, clay, or any other suitable material.

The opening 4 of the urn 1 may be in communication with the interior 5 of the urn 1. More specifically, contents may be added to the interior 5 of the urn 1 by passing the contents through the opening 4 at the top end 2 of the urn 1. The contents placed in the urn 1 may be, for example, the ashes of a loved one.

A lid 6 may be placed on the top end 2 of the urn 1. The lid 6 may have a top end 7 and a bottom end 8. If the lid 6 is generally cylindrical, then the bottom end 8 of the lid 6 may have a diameter 9 which is substantially similar to a diameter 10 located at the top end 2 of the urn 1. The lid 6 may allow a user to selectively open or close the urn 1 and gain access to the interior 5 of the urn 1.

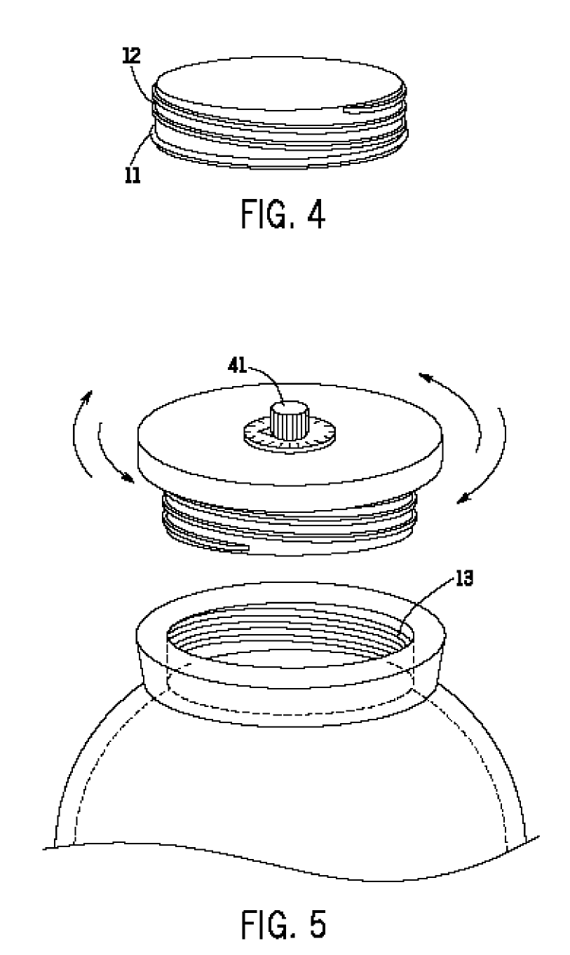

The lid 6 may have, for example, a gasket 11 (as visible in FIG. 4) surrounding a portion of the bottom end 8 of the lid 6. Preferably, the gasket 11 is made from rubber, silicone or plastic, but the gasket 11 may be made from any other suitable material. Alternatively, the gasket 11 may be a non-flexible gasket made from, for example, brass or another metal. While the lid 6 is placed on the top end 2 of the urn 1, the gasket 11 of the lid 6 may be in contact with the top end 2 of the urn 1. More specifically, the gasket 11 may form an air-tight and/or liquid tight seal between the lid 6 and the urn 1. As a result, any contents placed within the interior 5 of the urn 1 may be prevented from exiting the urn 1 without first removing the lid 6. Further, the lid 6 may have a locking device 41 such as, for example, a padlock (as illustrated in FIG. 5). The locking device 41 may require a code and/or a key in order to access the interior 5 of the urn 1.

As illustrated in FIG. 2, a portion of the lid 6 may have a threaded member 12. The threaded member 12 may mate with a matching threaded member 13 located at the top end 2 of the urn 1 (as illustrated in FIG. 1). More specifically, the lid 6 may be placed on the top end 2 of the urn 1. Because the diameter 9 of the lid 6 is substantially the same length as the diameter 10 of the top end 2 of the urn 1, the threaded member 12 of the lid 6 may be in contact with the threaded member 13 of the top end 2 of the urn 1. After the lid 6 is placed on the urn 1, the lid 6 is rotated so that the threaded member 12 of the lid 6 and the threaded member 13 of the urn 1 interlock with each other forming a seal. The lid 6 may then be held into place by, for example, gravity and/or friction. To open the urn 1, the lid 6 is rotated in the opposite direction as the rotation used to secure the lid 6 onto the urn 1. FIG. 5 illustrates the lid 6 being secured and/or removed from the urn 1.

Referring now to FIG. 3, the urn 1 of the present invention may not have a removable lid 6. Instead, the urn 1 may have only a hole 20 in which the contents may be added. After the contents are secured within the urn 1, the hole 20 may be sealed by, for example, a plug 21 having a threaded member 23 and or a gasket 24 (FIG. 3 illustrates the plug 21 having a threaded member 23 and a gasket 24). More specifically, the plug 21 may be, for example, a bolt. In this embodiment, the hole 20 is located at the top end 2 of the urn 1. In addition, a plurality of holes 20 may be present on the urn 1 to allow access to the interior 5 of the urn 1.

The lid 6 of the present invention may be secured into the urn 1 by means of the threaded member 12, the gasket 11, a bolt 20 or any combination of two or more of these securing devices.

The bottom end 3 of the urn 1 may be free from any holes. Known urns have a hole at the bottom end in which the contents are loaded into the interior of the urn. A bolt is then secured into the hole to keep the contents within the interior of the urn. The urn 1 of the present invention has a solid bottom end 3.

Although embodiments of the present invention are shown and described therein, it should be understood that various changes and modifications to the presently preferred embodiments will be apparent to those skilled in the art. Such changes and modifications may be made without departing from the spirit and scope of the present invention and without diminishing its attendant advantages. It is, therefore, intended that such changes and modifications be covered by the appended claims.

1) A burial urn comprising:
a housing having an interior;
a top end;
a bottom end, wherein the bottom end lacks any opening;
an opening for adding contents into the interior wherein the opening is located at the top end, and
a lid for closing the opening at the top end wherein the lid has a gasket.

2) The urn of claim 1 wherein the urn is biodegradable.

3) The urn of claim 1 further comprising:
a locking device for restricting access into the interior of the urn.

4) The urn of claim 1 further comprising:
a threaded member on the lid and a complementary threaded member located on at the top end of the urn.

5) The urn of claim 1 wherein an air tight seal is created when the lid is in contact with the top end.

6) The urn of claim 1 wherein a liquid tight seal is created when the lid is in contact with the top end.

7) The urn of claim 1 further comprising:
an opening located on the lid.

8) The urn of claim 7 wherein the opening of the lid is secured by a plug.

9) The urn of claim 8 wherein the plug is a bolt.

10) The urn of claim 1 further comprising:
a band around the lid.

11) The urn of claim 1 wherein the gasket is made from brass.

12) The urn of claim 1 further comprising:
a gasket around the lid.

13) The urn of claim 12 wherein the gasket is made from rubber.

14) The urn of claim 12 wherein the gasket is made from silicone.
